(19) United States
(12) Patent Application Publication
(10) Pub. No.: US 2014/0108412 A1
(43) Pub. Date: Apr. 17, 2014

(54) PRODUCT INFORMATION SYSTEM CONSULTABLE FROM SEVERAL MANUFACTURING SITES, BASED ON CONFIGURATION MANAGEMENT

(71) Applicant: LASCOM, VELIZY VILLACOUBLAY (FR)

(72) Inventors: Yannick MASSET, Forges Les Bains (FR); Sylvain LE TOUX, Bois D'arcy (FR)

(73) Assignee: LASCOM, VELIZY VILLACOUBLAY (FR)

(21) Appl. No.: 14/052,989

(22) Filed: Oct. 14, 2013

(30) Foreign Application Priority Data
Oct. 12, 2012 (FR) 12 59733

(51) Int. Cl. G06F 17/30

(52) U.S. Cl. CPC G06F 17/30598
USPC 707/740

(57) ABSTRACT

Provided is an information system relating to commercial products, consulted from several sites, this information being classed according to types of object, including items that make up the product, sites, characteristics; tables of links called configurations making it possible to view links between a parent object and child objects, including configurations between an item and characteristics. It contains a new object denoted site item. And items contain shared configurations directly linking the parent item to characteristics shared by all the sites, and specific configurations linking the parent item to specific characteristics of each site via a global specific configuration which directly links the parent item to site items, each site item being linked to the specific characteristics by specific configurations of its site.

### FIELD OF THE INVENTION

The field of the invention is that of information systems relating to commercial products manufactured on several sites, manufacturing being able to vary from one site to another.

### BACKGROUND OF THE INVENTION

The reader may recall that an information system is an IT system participating in the management, storage, processing, transport, distribution and consultation of the information within a company. It has the aim of promoting the circulation of information and effective access to the latter at the level of the whole company.

Among the functions carried out by such a system, the following may be seen:
data confidentiality so that the information is only accessible to those authorized to access it (authentication of people);
data availability so that they are accessible at the desired time by authorized persons;
data integrity so that they do not undergo any deliberate or accidental alteration or destruction, during their processing, their conservation or their transmission, and retain a format allowing them to be used;
data traceability (audit trail) making it possible to trace information accesses and access attempts and ensure such tracing is preserved and available for use.

In the following text we will focus more particularly on management, storage, processing and consultation of information.

Among these information systems, particular consideration will be given to those developed to manage information associated with the product during its lifecycle (Product Lifecycle Management), taking into account the problems:
of product management, i.e. problems of identification, version control and product classification, definition of product bill of materials, product documentation (electronic document), validation of the stages in the product lifecycles, etc., and
specific market sector problems, which may for example relate to problems related to formulation (optimization of experimental designs, simulation of properties and/or behaviour of a mixture, simulation of the effect of a process (mechanical, thermal), predictive microbiology).

Unlike businesses in the discrete manufacturing sector (aeronautics, automotive, mechanics, electronics etc.) that manufacture and assemble products, processed industries pertain to businesses that formulate, i.e. businesses that define products resulting from mixes or chemical reactions by chemical formulae, transform and form their products: such is the case in the food-processing, pharmaceuticals, cosmetics, chemicals and plastics industries which use “bulk” items (food ingredients, organic compounds or minerals etc.). Formulation is a central activity for these industries employing formulation professionals.

Information concerning commercial products may include information on composition, geographical manufacturing sites, third parties (client, supplier contacts etc.), and so on.

This information (or data) is grouped by type of object in an information system, on the one hand in a data repository, and on the other hand in libraries. This system is an IT system for centralized management of such information, which provides a global, real time view of the information; it is furthermore a system that may be consulted from several manufacturing sites, each site being equipped with an IT device linked to the central system.

Among the types of objects described in relation to FIG. 1 are:
items 10, which are all the elements entering into the composition of a product or into those of its logistical variants (LV),
geographical sites 30 used by the items in order to identify which industrial sites are manufacturing or purchasing; in both cases, the information is conveyed by a property sheet in the form of a pointer field,
third parties 40 who are used to identify any business in a relationship with the industrial company and notably the suppliers,
and various characteristics 20 associated with these data and which are grouped together in libraries.

The characteristics are grouped into libraries, the other objects (items, sites, third parties etc.) being grouped in the data repository.

In the following pages, we will consider products from a food-processing business, such as biscuits, as an example of a commercial product.

Items are simply any informational object that has properties. Items can be many things, such as a finished product, semi-finished product, raw material or ingredient, a document, a marketing specification, regulatory requirement, a piece of manufacturing equipment, or even a specific business workflow process.

Items may include:

raw materials (RM),

intermediate or semi-finished (SF) products, needed for the manufacture of another SF or of a manufacturing unit,

manufacturing units (MU), which are the finished products without packaging,

packing material for these units (PM) in the form of packaging in boxes, palettes etc. for example.

finished products (FP)=MU+primary and secondary packaging,

logistical variants (LV) which represent the logistical variations (packing) of a FP. This is generally a palettization plan (PM: palette, PM: film, PM: boxes, PFetc.) or a parceling plan.

etc.

Items RM and PM are purchased by industrial sites, whereas items LV, FP, MU and SF are manufactured on the sites.

Libraries of characteristics could be:

Costs,

Risks,

Nutrients,

Ingredients,

Geographical origins,

Packing data,

Technical data for packaging,

Technical data for raw materials,

General data,

Etc.

Each object has a property sheet enabling it to be identified; it is composed of fields intended to describe the object depending on its destination. For example, the property sheet of an object of item type will therefore not be the same as that of an object of geographical site type.

An object may be linked as needed, to associated files which are similar to attached documents, configurations, a history, or even other objects.

Certain objects have the potential to “evolve”, i.e. they are endowed with a “version” field. It is possible to consult the list of versions of an object from its “history”.

Configurations are tables of links between an object called the parent object and several objects called child objects, each connection (or link) being itself able to contain information; they allow the user to view or input information associated with an object from various angles. For example, the links between a item object such as a raw material or a manufacturing unit (parent object) and characteristics (child objects) originating from libraries such as cost characteristics (average price, provisional price, purchase price, cost price etc.) will make it possible to construct a “Costs-Price” configuration in which the values of these characteristics (=the information contained by the connections) will be entered.

It should be noted that a parent item may itself be linked to one or more other child items by a configuration 100, as in the example in FIG. 2 with the “composition” configuration that links the “parent” item 10 to several child items denoted 10′. According to the context, an item may therefore be denoted 10 or 10′.

It is then possible for the user to input or view the information relating to these links. This information may concern the existence of these links, or even values of these links. Configurations are typically presented to the user in the form of thumbnails, as may be seen in the examples of screen views in FIGS. 3B, 3C, 4B, 5B. A configuration is often named after the information that is input or viewed; but the same characteristics 20 may be used for various configurations 100, such as for example “General data” characteristics used both for a “General data” configuration and an “Environment” configuration, visible in FIG. 2.

Several configurations exist for a parent object; each of the configurations corresponds to a category of information relating to the object. But each configuration has only one connection with the object that it completes (=“parent” object), as may be seen notably in the examples in FIGS. 2, 3A and 4A. A configuration is presented in the form of a tree structure starting from the parent object, considered as the root of the tree, and makes it possible to describe a hierarchy between the elements forming it. This is the case for example for the “composition” and “ingredients” configurations 100, linked to the parent item 10. This tree may optionally have only one level more than that of the root; the term list is then used. These list-type configurations make it possible to list a series of characteristics defining an item, as is the case for the “risk”, “nutrition” etc. configurations.

Pointers to objects (PTO) are another method of inter-relating objects. Unlike a configuration, a PTO link does not make it possible to enter information on the link. It is therefore a simple thread leading from one object to another. These links are visible in the form of a field from the property sheet of an object. This field references identifiers of the objects pointed to. An identifier is a unique code from the sheet of an object; a click on one of the identifiers makes it possible to navigate to the pointed-at object.

An object is therefore linked to its property sheet, and generally to:
other objects by various configurations (Ingredients, Nutrition, Risks, Environment etc.) or by pointers,
associated files such as attached documents,
a history etc.,
   often presented in the form of thumbnails.

Libraries are elementary building blocks used for the construction of the configurations of the items. Unlike site objects and third party objects, which are also linked to the items by configuration or PTO, the libraries are not information specific to the company making use of the information system. In fact, they are more likely to be regulatory elements (nutrition, risks, ingredients etc.) or elements inherent in the profession (general characteristics, physico-chemical characteristics etc.)

Some examples of relationships of objects of item type will now be given.

An example of relationships of a “raw material” item 10 is shown in FIG. 3B. It is linked to its property sheet 5 and by a pointer from this sheet to other objects, in this instance geographical sites 30, and to other objects by various configurations 100 (Ingredients, Nutrition, Risks, Environment etc.). A zoom on a configuration 100, the “Ingredients” configuration in this instance, is also presented in this figure. An example of the “Ingredients” configuration 100 applied to an RM item “Liquid dark chocolate” is shown in FIG. 3B; an example of a “Costs-price” configuration 100 of an RM item, “Milk Chocolate”, is shown in FIG. 3C.

It will be noted that for the “Ingredients” configuration, the tree consists of 3 levels:

the root, in this instance the raw material item 10 (RM) which is labelled “liquid dark chocolate”,

then the level of the ingredients characteristics 20 labelled “cocoa paste” and “sugar”,

with finally for each ingredient its biological origin (cocoa for the cocoa paste, beet for the sugar), and the corresponding geographical origin (or origins).

The “Costs-price” configuration contains only two levels.

An example of relationships of an item 10, “packaging”, is shown in FIG. 4A. It is related to its property sheet 5, to geographical sites 30 and to other objects by various configurations 100 (Technical data, Suppliers, Risks, Environment etc.) An example of “Technical data” configuration of one such item is shown in FIG. 4B.

For a company owning several production sites, it is still necessary for a same item object to be referenced for each site using it. This multiple referencing is explained by the need to enter characteristics in certain configurations that are specific to the site using this item.

The variations of these items according to the sites require a duplication of information as illustrated in FIG. 5A for an item 10 RM “Cocoa” used over N sites, site1, site 2, . . . siteN with for each site the property sheet and all its configurations. In this figure only a few configurations of the RM item have been shown for a better understanding; but of course each configuration is itself related to characteristics.

This presents several drawbacks.

This does not make allow to have a global view of the characteristics of an item object such as RM or EMP. For example, it is not possible to consult at the same time the purchase prices of the different sites. To do that, it is necessary to consult the “Cost-Price” configuration of each item object of each of the sites, as illustrated in FIG. 5B where two screen views are reproduced, for the “Cost-Price” configuration of the item 10 RM “Thin Cocoa”, one for a site1 and the other for a site2, this distinction according to the site appearing only in the property sheet of the item RM; the price values differ from one screen view to another. Because of this, it is difficult to have a global view of the characteristics of a raw material for example, whatever the site.

It is also difficult to keep the information updated: the duplication of the information for a same item object RM or PM peer site, demands the modification of the same information at various places, at the risk of having erroneous information in the system.

Searches are disturbed: the information being duplicated as many times as there are sites using a same item object of RM type or PM type for example, this latter appears as many times in the repository as there are sites using it. This is disturbing for the user who expects to see just a single item of information for a given reference defined by the user, and this is prone to errors. He or she must therefore be particularly careful in order to consult the correct item of information depending on what site he or she belongs to.

The aim of the invention is to mitigate these drawbacks.

### SUMMARY OF THE INVENTION

The invention is based on the introduction of a new type of object denoted “site item”.

More precisely, the subject of the invention is an information system relating to commercial products, which is intended to be consulted from several sites, this information being classed according to types of object, certain types of object including items that make up the commercial product and sites, being grouped into a repository, other types of objects, characteristics being grouped into libraries, tables of links called configurations making it possible to view links between an object called the parent object and at least one other object called the child object and/or to input values relating to these links, including configurations between an item and characteristics.

It is mainly characterized in that it contains a new type of object denoted site item, and in that at least one item called the parent item contains at least one so-called shared configuration directly linking the parent item to characteristics shared by all the sites, these characteristics furthermore having the same values for each site, and at least one so-called specific configuration linking the parent item to specific characteristics of each site via a global specific configuration which directly links the parent item to site items, with one site item per site, each site item being itself linked to the specific characteristics of its site by specific configurations of its site, and in that the parent item contains a property sheet with a link to each site item.

These site items make it possible to carry just the specific configurations of items with dual configurations such as items purchased (RM and PM) by the various industrial sites.

The advantage of using site items lies in the location of products by the manufacturers. Rather than duplicating the items by site, for example a same flour used on the site A and the site B, a single item carrying the shared configurations is created, which avoids duplication of the information. To this item are added site items at a rate of one site item per site, the aim of these site items being to describe the variations in information between sites.

Items with shared and specific configurations may themselves be child items.

The commercial products are notably food products.

### BRIEF DESCRIPTION OF THE DRAWINGS

Other characteristics and advantages of the invention will appear on reading the detailed description below, given by way of non-limiting example and with reference to the appended drawings in which:

FIG. 1 already described schematically represents the classification of various types of object in an information system according to the state of the art,

FIG. 2 already described schematically represents an example of links between a root object, here an item, its configurations and its child objects, here characteristics,

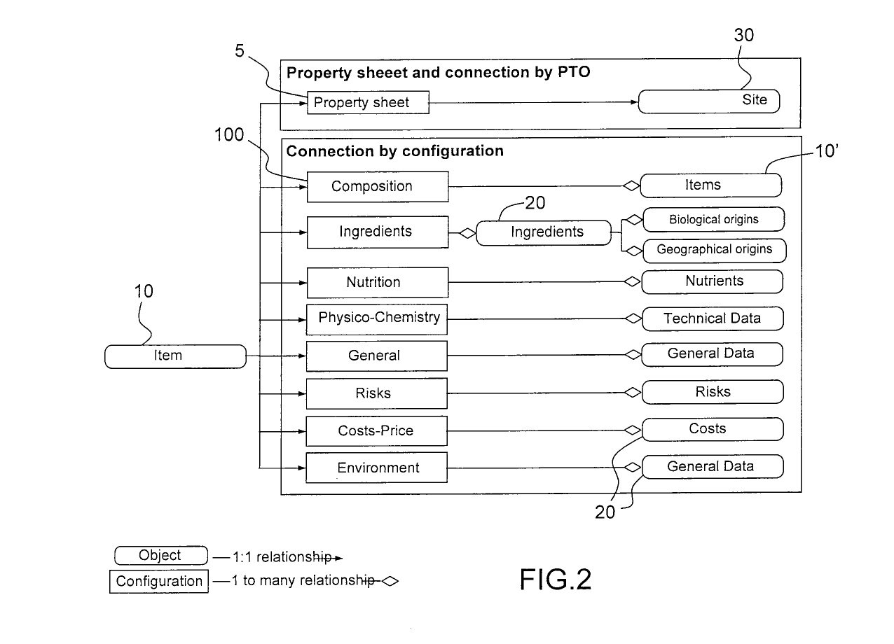

FIG. 3A already described schematically represents an example of links of an item “RM,”

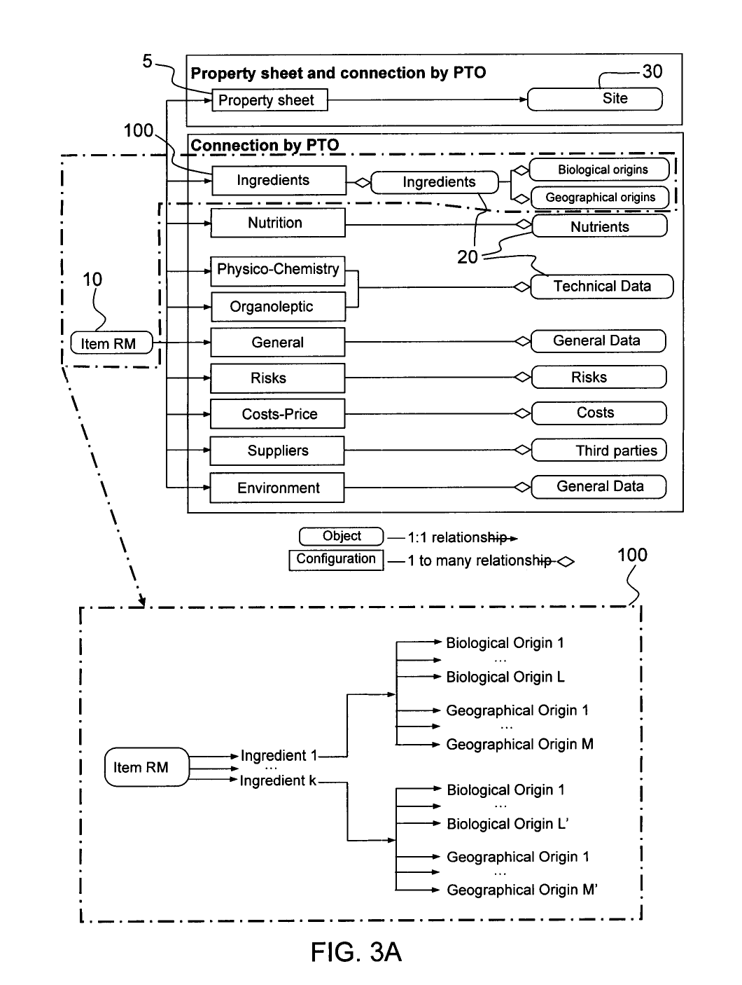

FIG. 3B already described schematically represents a screen view for the “Ingredients” configuration corresponding to the item “RM,”

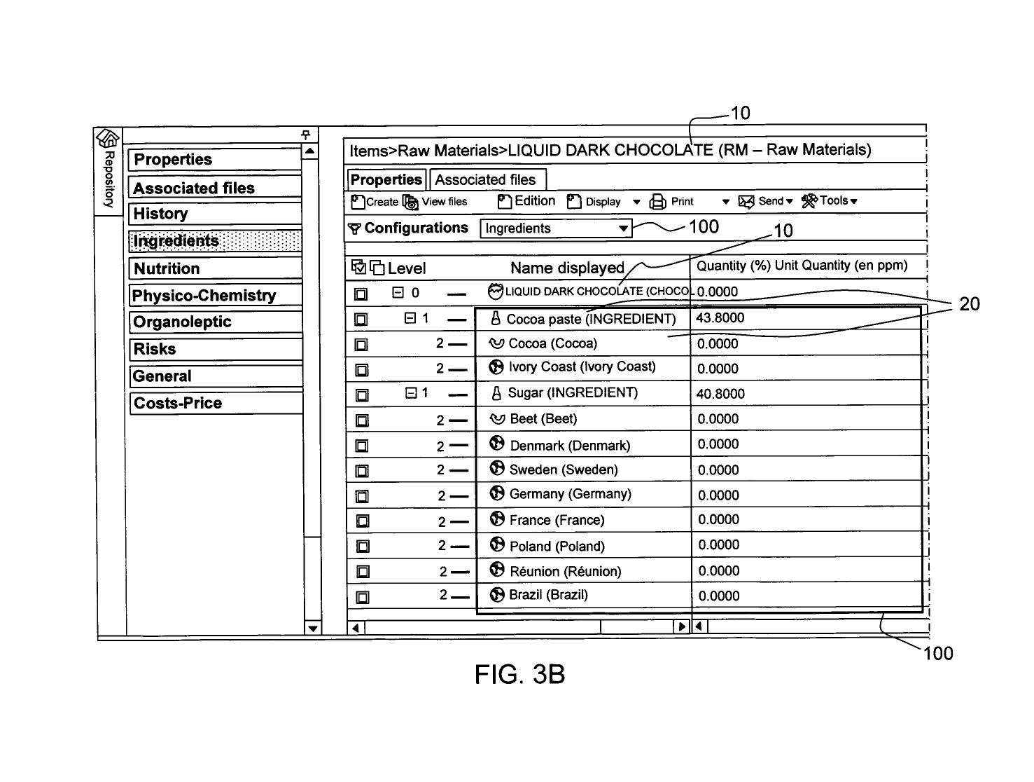

FIG. 3C already described schematically represents a screen view for the “Costs-Price” configuration corresponding to the item “RM,”

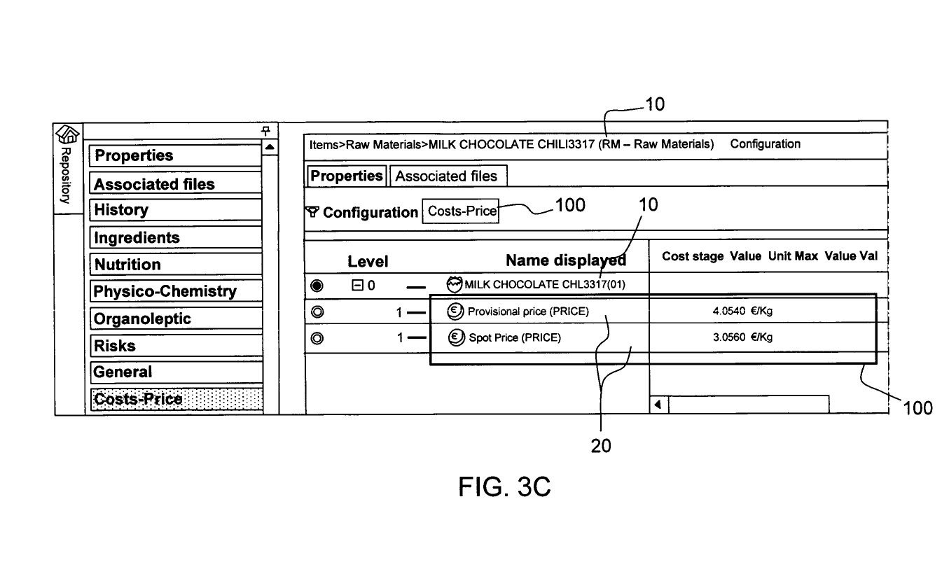

FIG. 4A already described schematically represents another example of links of an item “PM,”

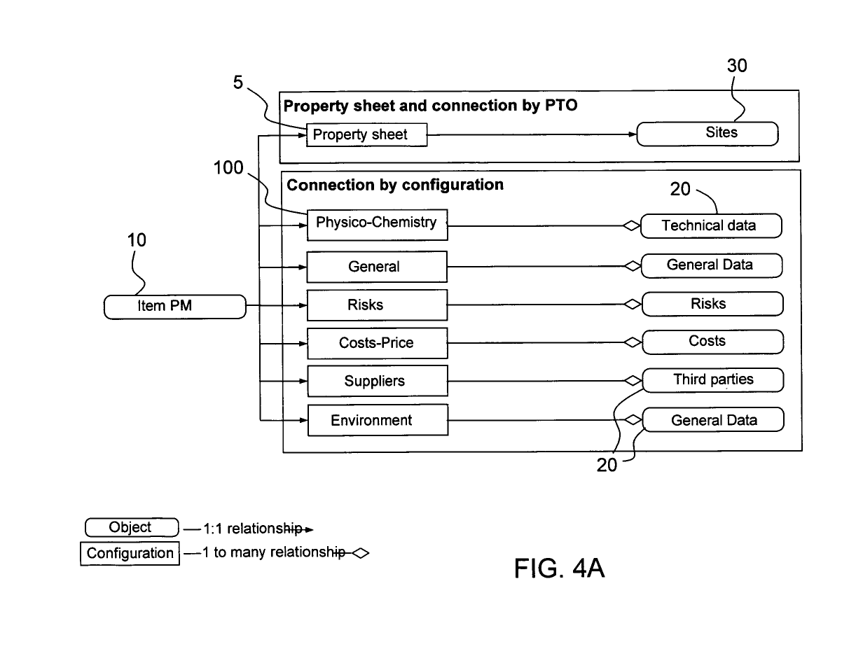

FIG. 4B already described schematically represents a screen view for the “Technical Data” configuration corresponding to the item “PM,”

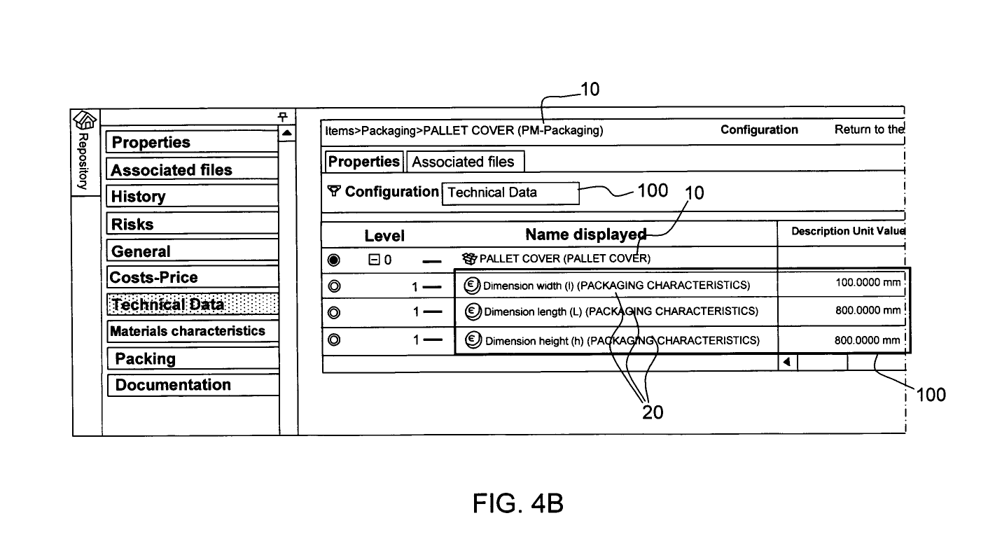

FIG. 5A already described schematically represents the retrieval of characteristics via configurations and the duplication of this information for each site,

FIG. 5B already described schematically represents examples of screen views corresponding to two sites of FIG. 5A,

FIG. 6 is a schematic illustration of an example of configurations shared by all the sites and of specific configurations, according to the invention,

FIG. 7A is a schematic illustration of the use of a new type of object denoted site item according to the invention,

FIG. 7B is a schematic illustration with links of configuration type between an item and its site items,

FIG. 7C is a schematic illustration with links of configuration type between an item and its site items,

FIG. 7D is a schematic illustration with links originating from a site item,

FIG. 8A is a schematic illustration of the retrieval of characteristics via configurations, according to the invention,

FIG. 8B is a schematic illustration of a screen view for three sites corresponding to the characteristics via configurations of FIG. 8A, and

FIG. 8C is a schematic illustration of a screen view of a property sheet of an item.

The same elements bear the same references from one figure to another.

### DETAILED DESCRIPTION OF THE PREFERRED EMBODIMENTS

Certain items (for example of LV, FP, MU or SF type) are specific to a given site; these are items that point towards at least one other item, i.e that have at least one child item. This means that all their configurations are linked to the geographical location of the site (environmental impact, transport cost etc.) i.e. that the values of the characteristics associated with these configurations vary according to site, as well as possibly the characteristics themselves.

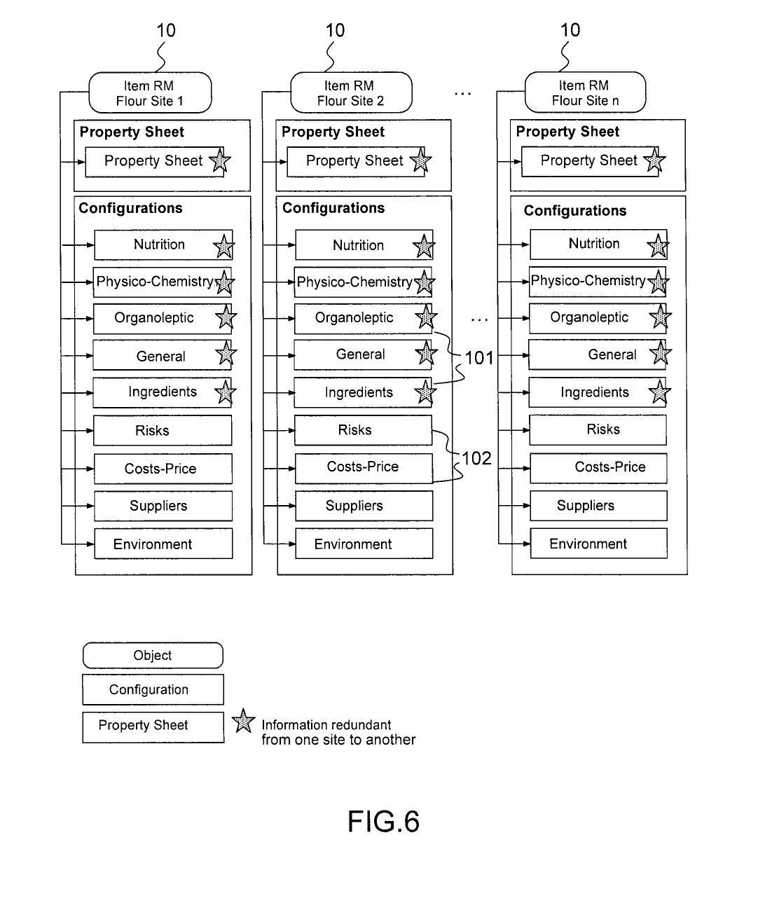

For other items that do not point towards other items such as the purchased items RM and PM, described in relation to FIG. 6, certain configurations 101 are shared by all the sites, i.e. not only the characteristics associated with these configurations are the same from one site to another (there are for example nutritional characteristics of glucid and lipid content for each site) but also the values of these characteristics (the glucid and lipid rates are the same from one site to another); the other configurations 102 are on the contrary specific to each site, i.e. not only the values of the characteristics associated with these configurations vary from one site to another, but possibly the characteristics themselves may vary according to site. These items are denoted items with dual configurations: shared and specific.

For a company owning several production sites, the variations according to the sites of these dual-configuration items require a duplication of information, with for each site certain configurations being shared by all the sites and therefore duplicated identically, and the other configurations varying according to each site.

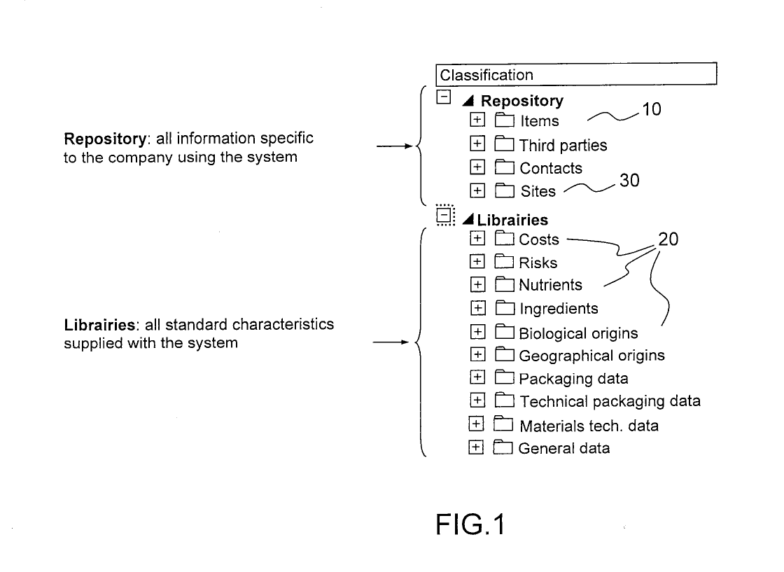

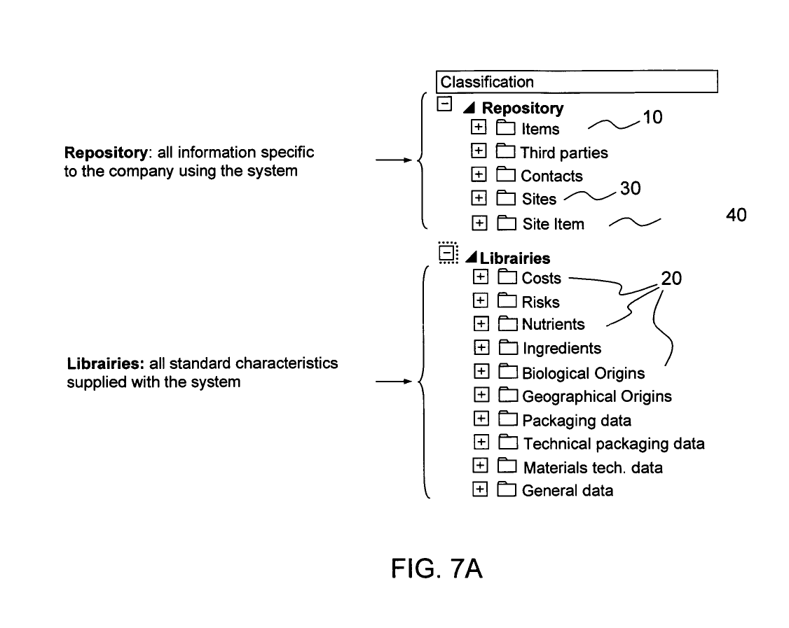

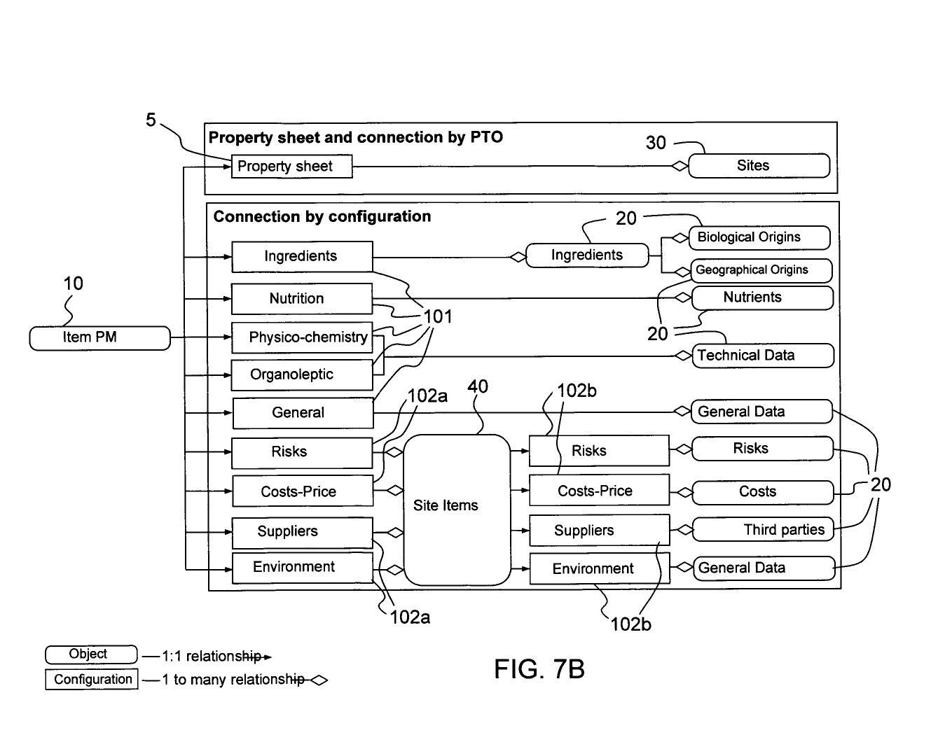

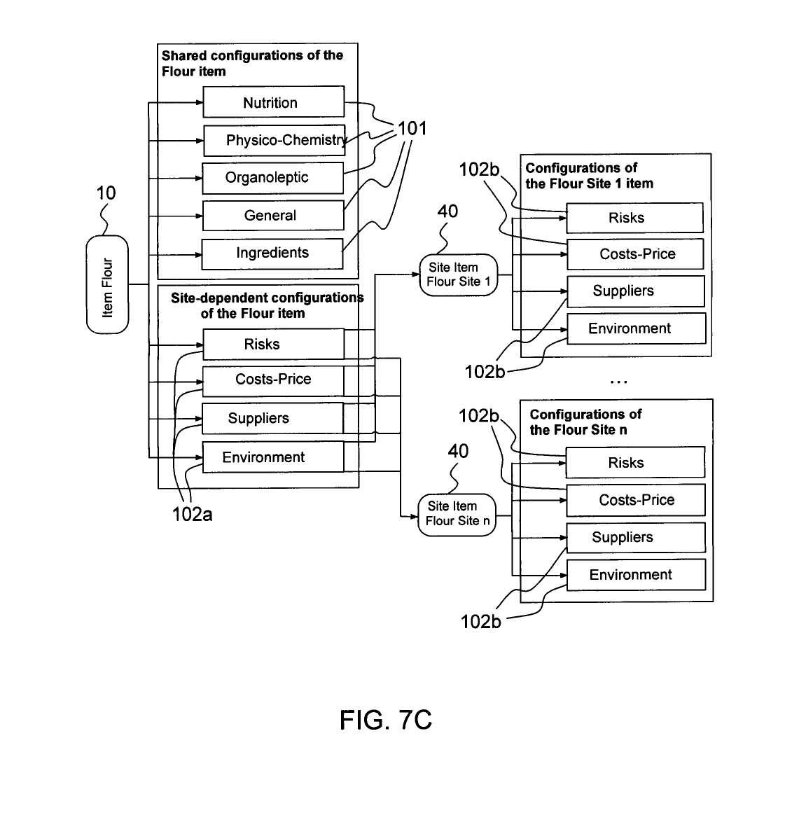

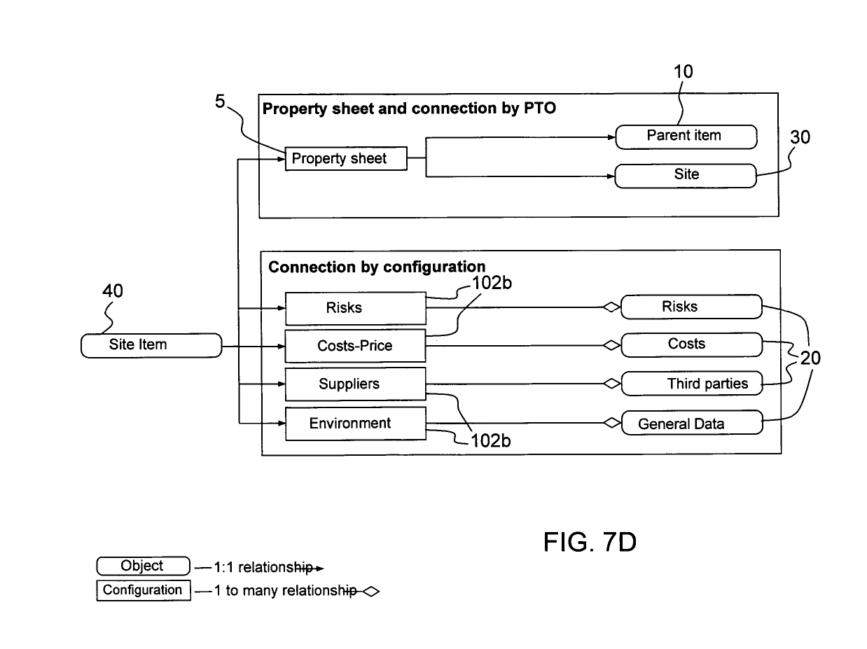

The invention is based on a new type of object denoted “site item” 40. This equates to adding to the list of 4 objects in the Repository in FIG. 1, a fifth object denoted site item 40, as shown in FIG. 7A.

According to the invention described in relation to FIGS. 7, rather than duplicating the items by site, for example for a flour used on site1, site2, . . . and site N, a single item 10 bearing the shared configurations is created, which avoids duplication of information. And N site items 40 are created, one for site1, the next for site2, . . . , the Nth for site N, each site item 40 carrying the configuration differences between sites. This concerns only items which have configurations shared by all sites and also configurations specific to each site. The site item 40 objects make it possible to carry the variations of characteristics of the item 10 objects that vary according to the industrial sites.

In our example, only the items 10 RM and PM, which are purchased by each site, are dual-configuration items. FIGS. 7B and 7C with an RM item “Flour” highlight the fact that:

shared configurations 101 directly link the parent item 10 to the shared characteristics 20; there is only one level of configuration between the parent item and its shared characteristics. In other words, we have:
parent item-configuration-shared characteristics, the dashes “-” representing direct links.

specific characteristics 20 (of risks, costs, third party and environment in our example) are no longer linked to the configurations of the “parent” item 10 directly (=are no longer linked to the parent item by a single level of configurations), but by two levels of configurations between which a site item 40 is inserted. In other words, we have:
parent item-global specific configuration-site items-site specific configurations-specific characteristics.

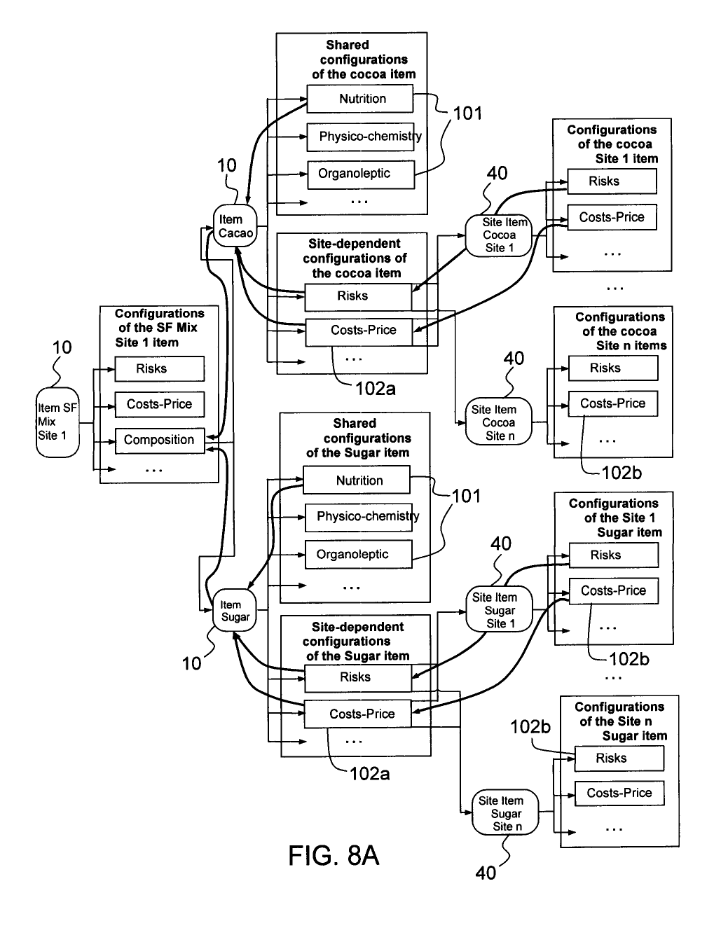

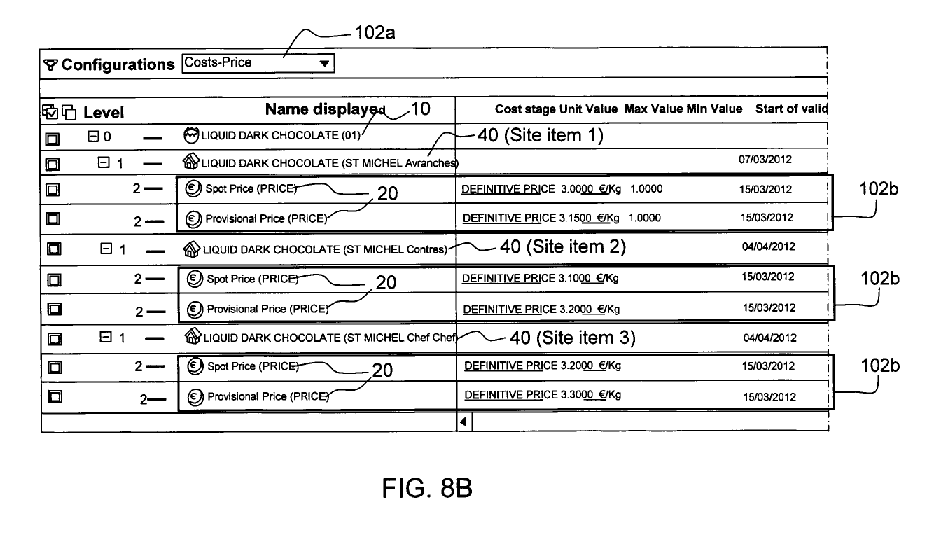

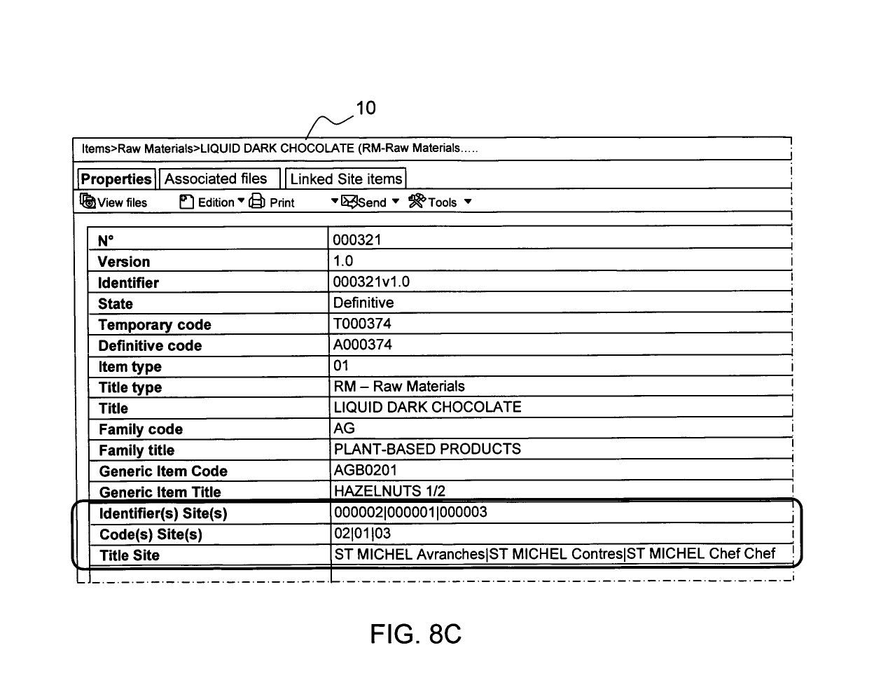

More precisely, a site specific configuration 102b directly links a site item to specific characteristics of the site, and a global specific configuration 102a directly links a parent item 10 to site items 40 as may be seen in FIG. 8A, this global specific configuration 102a encompassing the site specific configurations 102b as shown in the example in FIG. 8B.

A site item 40 object has in its property sheet a link such as a field of PTO type towards the item object 10 that it complements (=parent item) and a link such as a PTO field towards a unique site object 30, as may be seen in the example in FIG. 7D. It does not have the same properties sheet as an item 10 object which typically points towards several site objects 30; this is indeed a different type of object.

When a site item 40 is created, the following are automatically added to its parent item 10:

the site item 40 in the configurations that it possesses itself (e.g addition of the site item in the “Costs-Price” configuration of the parent item),

in the property sheet of the parent item 10, an example of which is shown in FIG. 8C: the site of the site item of the link (PTO field for example) towards the property sheet of the site item. Three site items having been created, the three corresponding sites (St-Michel Avranches, St-Michel Contres and St-Michel Chef) appear in the field labelled site of the property sheet of the parent item “Liquid Dark Chocolate”.

Items 10 that point towards other items 10′ (for example manufactured items such as LV, FP, MU, SF), unlike items 10 that do not point towards other items (for example purchased items such as RM, PM), do not have a direct relationship with site items 40. For technical reasons mainly related to the production line, a manufactured item is linked to a single site only. On the other hand, for the development of these manufactured items, purchased items (RM,PM) linked to site items are used via one or more configurations such as the composition configuration in our example, but these manufactured items are not directly linked to site items.

Although it is contrary to the prior art, information relating to a dual-configuration item requires new objects (site items), which offers several advantages.

In the preamble we have seen that upon creation of the nutrition, ingredients, risks, costs-price and environment configurations of a manufactured item based on characteristics carried by the purchased items, the user must select the items linked to the site of the manufactured item to create the composition configuration, but this involves a risk of error.

With the introduction of site items according to the invention, the creation of a composition configuration is much simpler since there is now only one purchased item for all the sites for a given reference, defined by the user. There is therefore no possibility of error in the choice of the item according to the site of the manufactured item.

A manufactured item 10 (LV, FP, MU, SF) has on its property sheet its membership site 30 (=of manufacture) As a function of the latter, the system according to the invention is capable of retrieving the information relating to the site items 40 provided by the purchased items (RM and PM) used in the composition configuration of the manufactured item, as shown in FIG. 8A.

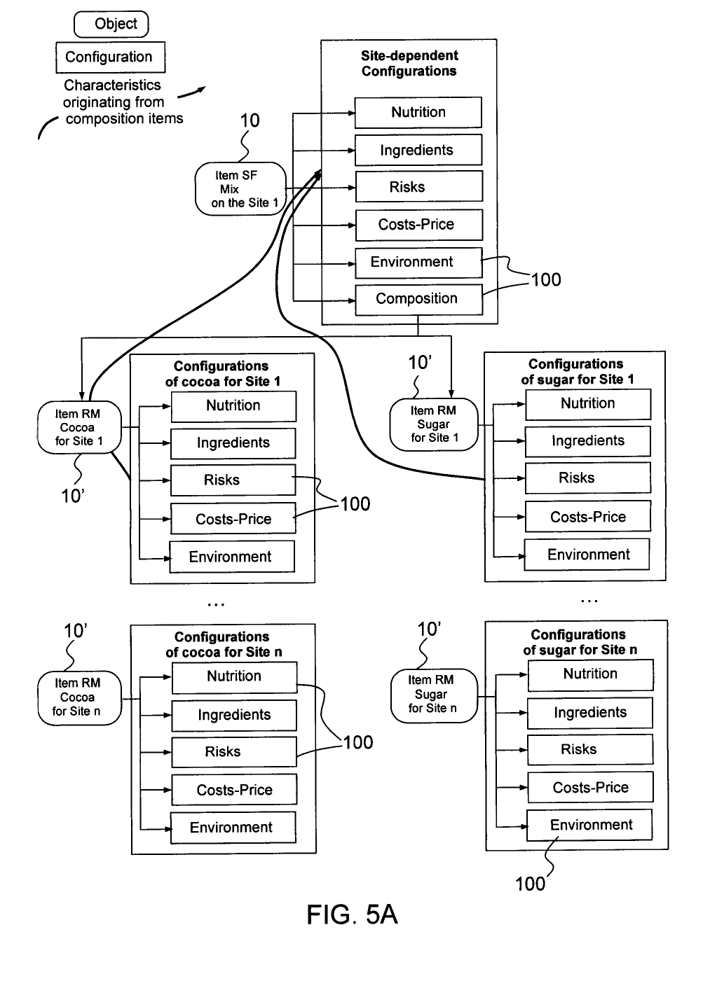

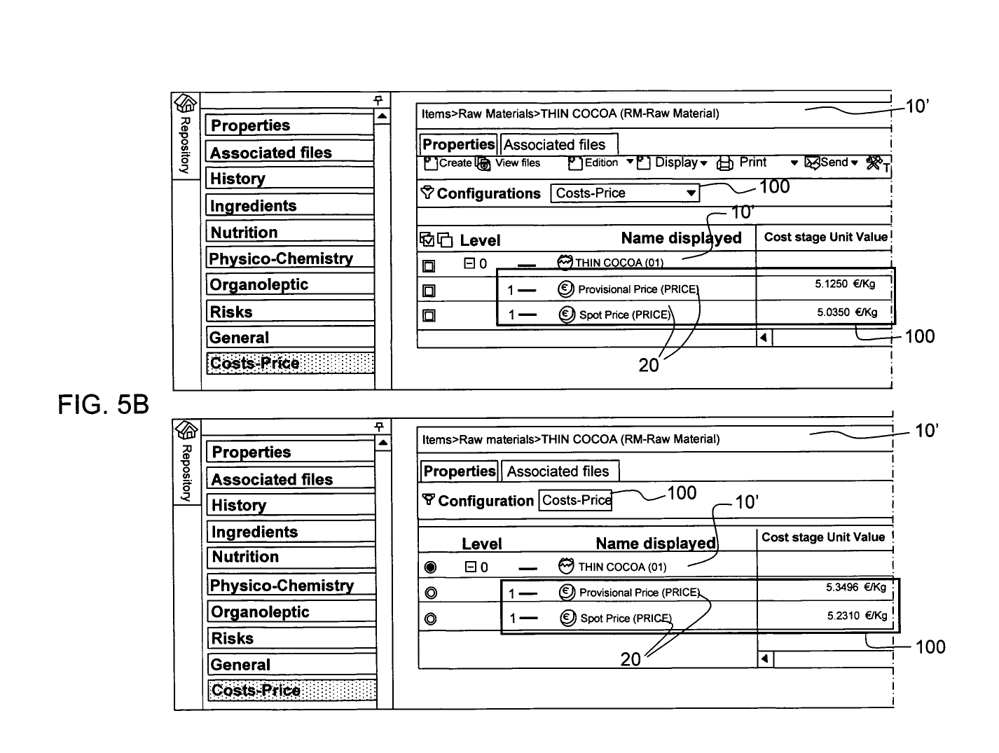

Site items 40 also make it possible to have a global multi-site overview of the characteristics of a “raw materials” item 10 as illustrated in FIG. 8B; this was not possible in the prior art (cf FIG. 5B).

Updating of the information is facilitated. In fact, there is no longer any redundant information relating to configurations shared by all sites because there is now only one item for a reference of RM or of PM, defined by the user. This removes the possibility of forgetting to update information, as described in the preamble.

Searches are no longer disturbed. In fact, there is now only one item for a reference of RM or of PM, which removes the problem of the search returning the same item as result several times.

An information system for food products has been described. The invention also applies to information systems for cosmetic products, pharmaceuticals, chemicals, plastics, and more generally to products whose manufacture may vary from one site to another, due to local variations of the supply chain.

1. An information system relating to commercial products, which is intended to be consulted from several sites, this information being classed according to types of object, certain types of object including items that make up the commercial product and sites, being grouped into a repository, other types of objects, characteristics being grouped into libraries, tables of links called configurations making it possible to view links between an object called the parent object and at least one other object called the child object and/or to input values relating to these links, including configurations between an item and characteristics, wherein it contains a new type of object denoted site item, and in that at least one item called the parent item contains at least one so-called shared configuration directly linking the parent item to characteristics shared by all the sites, these characteristics furthermore having the same values for each site, and at least one so-called specific configuration linking the parent item to specific characteristics of each site via a global specific configuration which directly links the parent item to site items, with one site item per site, each site item being itself linked to the specific characteristics of its site by specific configurations of its site, and in that the parent item contains a property sheet with a link to each site item.

2. The information system according to claim 1, wherein items with shared and specific configurations are themselves child items.

3. The information system according to claim 1, wherein the commercial products are food products.
